(19) United States
(12) Patent Application Publication
(10) Pub. No.: US 2002/0106048 A1
(43) Pub. Date: Aug. 8, 2002

(54) Creep resistant zirconium alloy and nuclear fuel cladding incorporating said alloy

(75) Inventors: Raymond Grant Rowe, Schenectady, NY (US); Ronald Bert Adamson, Fremont, CA (US); Sheikh Tahir Mahmood, Pleasanton, CA (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/773,782

(22) Filed: Feb. 2, 2001

(51) Int. Cl. G21C 3/00

(52) U.S. Cl. 376/416

(57) ABSTRACT

The present invention provides a creep resistant zirconium alloy comprising a coarse grained lath alpha microstructure. The microstructure can include small second phase precipitates. The small second phase precipitates can have a diameter less than 0.15 μm. The microstructure can be partially recrystallized. The microstructure is an acicular structure and can include a lath spacing within the range from about 0.5 to about 3.0 μm. The microstructure is an acicular structure and can include a lath spacing within the range from about 0.5 to about 3.0 μm. The present invention provides a nuclear fuel cladding comprising an annular layer of the creep resistant zirconium alloy. The present invention also provides a method of manufacturing a creep resistant zirconium alloy comprising the steps of beat heat treating a zirconium alloy to form a first intermediate, fast quenching the first intermediate to form a second intermediate, cold working the second intermediate within the range from about 30% to about 40% to form a third intermediate, and annealing the third intermediate to effect partial recrystallization.

### BACKGROUND OF THE INVENTION

The present invention relates to a novel zirconium alloy, and more particularly, to a creep resistant zirconium alloy and a method of manufacture thereof, and a nuclear fuel cladding incorporating such alloy.

Nuclear reactors utilize water as a coolant for the reactor and the produced steam as a source of energy to power steam turbines to thereby provide electrical energy. Nuclear reactors typically have their nuclear fissionable material contained in sealed cladding tubes, generally of a zirconium alloy, for isolation of the nuclear fuel from the water and/or steam. Zirconium and its alloys are widely used as nuclear fuel cladding since they advantageously possess low neutron absorption cross-sections, and at temperatures below about 398° C. (the approximate core temperature of an operating nuclear reactor), are non-reactive and importantly possess high corrosion resistance relative to other metal alloys in the presence of de-mineralized water or steam. Two widely used zirconium alloys (“Zircaloys”) are “Zircaloy-2” and “Zircaloy-4”. Zircaloy-2, a Zr-Sn-Ni-Fe-Cr alloy, is generally comprised (by weight) of approximately 1.2-1.7% tin, 0.13-0.20% iron, 0.06-0.15% chromium and 0.050-0.08% nickel. Zircaloy-4 has essentially no nickel, and about 0.2% iron, but is otherwise substantially similar to Zircaloy-2. Zircaloy-2 has enjoyed widespread use and continues to be used at present in nuclear reactors. Zircaloy-4 was developed as an improvement to Zircaloy-2 to reduce problems with hydriding, which causes Zircaloy-2 to become brittle when cooled to ambient temperatures (ie. when the reactor is shut down) after absorbing hydrogen at higher temperatures.

Zirconium alloys are among the best corrosion resistant materials when exposed to steam at reactor operating temperatures (less than 398° C., typically 290° C.) in the absence of radiation from nuclear fission reactors. The corrosion rate in absence of neutron bombardment is very low and the corrosion product is a uniform, black Zr0₂ oxide film/layer which forms on exterior surfaces of Zircaloy exposed to high temperature steam (uniform corrosion). The black oxide layer of Zr0₂ usually contains a small (non-stoichiometric) excess of zirconium, and as such, it contains excess electrons giving it a black or grey colour. It is also highly adherent to zirconium or Zircaloy surfaces exposed to steam.

Despite its corrosion resistant qualities, nuclear fuel cladding containing Zircaloy-2 has been known to suffer brittle fracture in a hydrogen gas environment. Such brittle fracture is believed to be attributable to secondary failure of the cladding. Secondary failure occurs after initial perforation of fuel cladding allows steam into the interior of the cladding tube. Steam tends to react with zirconium and its alloys to produce hydrogen gas in accordance with the following reaction:

Zr+2H₂O→2H₂+Zr0₂

Because gas permeability is typically limited in nuclear fuel rods, a hydrogen rich atmosphere, with a very low H₂O partial pressure, is generated inside the cladding, often far from the initial perforation, especially if crack growth is significant. The pressure in the hydrogen rich atmosphere is believed to be approximately 1000 psi, which is the pressure experienced inside the cladding near the perforation. Under these conditions, Zircaloy-2 cladding becomes susceptible to hydrogen embrittlement followed by failure by brittle fracture. It is, therefore, desirable to improve resistance of Zircaloy-2 cladding to cracking while retaining resistance to fast fracture.

### SUMMARY OF INVENTION

The present invention provides a creep resistant zirconium alloy and a method of manufacture thereof.

In one aspect, the present invention provides a creep resistant zirconium alloy comprising a coarse grained lath alpha microstructure. The microstructure can include small second phase precipitates. The small second phase precipitates can have a diameter less than 0.15 μm. The microstructure can be partially recrystallized. The microstructure can be less than 50% recrystallized. The microstructure can be an acicular structure and can include a lath spacing within the range from about 0.5 to about 3.0 μm.

In another aspect, the present invention provides a nuclear fuel cladding comprising an annular layer of creep resistant zirconium alloy comprising a coarse grained lath alpha microstructure.

In yet another aspect, the present invention provides a method of manufacturing a creep resistant zirconium alloy comprising the steps of beta heat treating a zirconium alloy to form a first intermediate, fast quenching the first intermediate to form a second intermediate, cold working the second intermediate within the range from about 30% to about 40% to form a third intermediate, and annealing the third intermediate to effect partial recrystallization. The beta heat treating step can have a duration within the range from about 1 to about 10 seconds. The fast quenching step can be conducted at a cooling rate within the range from about 20 to about 200° C./second. The annealing step can be conducted within the temperature range from about 570° C. to about 640° C.

Creep resistance in nuclear fuel cladding is improved by incorporating a zirconium alloy having a partially recrystallized acicular structure with small second phase precipitates. The lath spacing in the acicular structure provides significant obstacles to dislocations during high strain rate creep.

It is observed that a zirconium alloy having a certain microstructural configuration and increased resistance to creep, has increased resistance to hydrogen gas cracking. In this regard, experimental results suggest hydrogen gas fracture of zirconium alloy is controlled by the rate of creep at the crack tip in the zirconium alloy. Accordingly, the applicants have discovered a zirconium alloy of a particular microstructure which has increased resistance to creep, results in a zirconium alloy with increased resistance to hydrogen cracking. The applicants propose use of such alloy in nuclear fuel cladding due to such alloy's increased resistance to hydrogen cracking which is problematic with existing zirconium and zirconium alloy fuel cladding.

Accordingly, in a further aspect, the invention comprises a fuel cladding for use in a nuclear reactor having a microstructure in one or more of the embodiments disclosed above. More particularly, in a broad aspect of such embodiment of the invention, then invention comprises a fuel cladding for use in a nuclear reactor, for cladding nuclear fuel, comprising:

a tube member; and

said tube member comprised of a zirconium alloy, said alloy having a coarse grained lath alpha microstructure.

In a further aspect, the invention comprises a fuel cladding for use in a nuclear reactor or for cladding nuclear fuel, comprising:

a tube member; and

said tubular member having an inner annular layer, said annular layer comprised of a zirconium alloy, having a course grained lath alpha microstructure.

The inner annular layer forms an inner diameter of the tubular member.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1A is a schematic view of fuel cladding with creep resistant internal layer;

FIG. 1B illustrates Detail “A” of FIG. 1;

FIG. 2A is a graph of crack length vs time for plate A which was loaded at a stress intensity 30-32 ksi√in in 750 psig hydrogen gas at temperatures of 250° C. and 325° C. in Example 1;

FIG. 2B is a graph of crack length vs time for plate B which was loaded at a stress intensity 30-32 ksi√in in 750 psig hydrogen gas at temperatures of 250° C. and 325° C. in Example 1;

FIG. 3A is a graph of crack growth rate vs nominal stress intensity for plate A tested in air and in high pressure hydrogen gas at a nominal starting stress intensity of 32 ksi√in in Example 1;

FIG. 3B is a graph of crack growth rate vs nominal stress intensity for plate B tested in air and in high pressure hydrogen gas in Example 1, commencing at a nominal stress intensity of 32 ksi√in

FIG. 4A is a graph of yield strength of cold-worked and recrystallized Zircaloy-2 in Example 1;

FIG. 4B is a graph of 300° C. creep curves for cold-worked and recrystallized Zircaloy-2 in Example 1;

FIG. 5A is a graph of crack length vs time for plates A and B which were loaded in air at ˜30 ksi√in in stress intensity at 325° C. in Example 1;

FIG. 5B is a graph of crack length vs time for plate B which was incrementally loaded to a stress intensity of 38 ksi√in at 325° C. after ˜5000 sec at 32 ksi√in in Example 1;

FIG. 6A is a graph of crack growth rate vs stress intensity for plates A and B which were tested in air at a nominal initial stress intensity of 30 ksi√in in Example 1;

FIG. 6B is a graph of crack growth rate vs stress intensity for plates A and B at 325° C. wherein Plate A was tested at an initial stress intensity of 32 ksi√in and plate B was stepped to 38 ksi√in from 32 ksi√in in Example 1;

FIG. 7 is a schematic illustration of the dimensions of a CT fracture specimen used in Example 1; and

FIG. 8 is a graph of stress intensity vs crack length in the CT fracture specimen of FIG. 7 for applied loads of 1275, 1488 and 1688 lbs.

### DETAILED DESCRIPTION OF THE INVENTION

Superior creep resistant zirconium alloy is provided for use in nuclear fuel cladding. The creep resistant zirconium alloy is a coarse grained lath alpha zirconium alloy microstructure. “Coarse grained” refers to size of grain boundary and encompasses grains with a size greater than 0.15 μm.

The microstructure includes small second phase precipitates, such as Fe or Cr, characterized by a particle size diameter no greater than 0.15 μm. In one embodiment, the particle size diameter is less than 0.10 μm. Small second phase precipitates promote creep resistance qualities as they dissolve during irradiation within a nuclear reactor environment, thereby imparting extra strength to the alloy. Without wishing to be bound by theory, it is believed that this can occur by solid solution hardening by Fe dissolved in the matrix, and dispersion hardening by Cr-rich areas in the matrix which are residuals from the original second phase precipitates.

The microstructure is partially recrystallized. In one embodiment, the microstructure is less than 50% recrystallized. Full recrystallization would destroy the lath structure, and is undesirable. Also, under full recrystallization, second phase precipitates would be larger.

In one embodiment, the microstructure is a lath or acicular structure and includes a lath (or interlamellar boundary) spacing of 0.5 to 3.0 μm. Without wishing to be bound by theory, it is believed that the lath spacing provides significant obstacles to dislocations during high strain creep. The lath spacing in the structure create an effective grain size much smaller than the apparent conventional grain size.

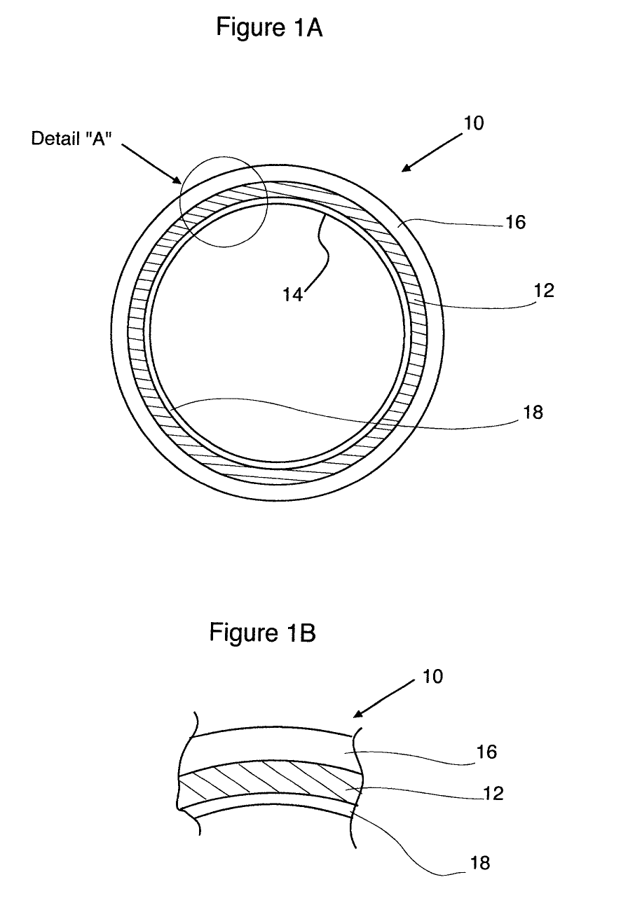

Referring to FIGS. 1A and 1B, in one embodiment, an annular layer 12 of the above-described creep resistant zirconium alloy can be provided near the inside diameter 14 of fuel cladding 10, while retaining fast fracture resistant and corrosion resistant Zircaloy-2 on the outer portion 16 of the cladding. An annular layer 12 of such creep resistant zirconium alloy provided between a zirconium barrier layer 18 and the Zircaloy-2 cladding 16 of either conventional barrier fuel cladding or Triclad^{®} fuel cladding would help prevent hydrogen gas cracking from inside the cladding.

A method of manufacturing a creep resistant zirconium alloy will now be described. This method comprises the steps of heat treating a zirconium alloy, such as Zircaloy-2, to form a first intermediate, fast quenching the first intermediate to form a second intermediate, cold working the second intermediate within the range of from about 30% to about 40% to form a third intermediate, and annealing the third intermediate to effect partial recrystallization and formation of a creep resistant zirconium alloy.

In one embodiment, the heat treatment is a beta heat treatment wherein the zirconium alloy is heat treated at a temperature where zirconium exists in the beta phase (i.e. at a temperature above about 965° C.). The duration of the beta heat treatment is about 1-10 seconds or of a sufficient duration to dissolve all the second phase precipitates. If the beta heat treatment takes too long, grain size becomes too large, compromising mechanical properties.

After heat treatment, the first intermediate is quenched at a high rate to form a second intermediate. In one embodiment, the cooling rate during this quench is within the range from about 20 to about 200° C./second. A high quench rate promotes small second phase precipitate particle size and high solute retention in the matrix of the creep resistant zirconium alloy. This is needed for resistance to nodular corrosion in a boiling water reactor. If cooling rate was too slow, large second phase precipitate particles would form. If cooling rate was too fast, very few second phase precipitates would form, and there would be poor uniform corrosion in a boiling water reactor environment.

After quenching, the second intermediate is cold worked within the range from about 30% to about 40% to form a third intermediate. Further cold work would promote full recrystallization during the subsequent annealing step. With less cold work, recrystallization may not be realized, and other properties such as irradiation growth and corrosion may be less desirable.

After cold working, the third intermediate is annealed at an elevated temperature to effect partial recrystallization. In one embodiment, the annealing is conducted with the temperature range from about 580° C. to about 640° C.

The present invention will be described in further detail with reference to the following non-limitative example.

### EXAMPLE 1

Two plates of Zircaloy-2 were compared. Plate A was cold rolled 51% from an as-hot rolled Zircaloy-2 plate nominally one inch thick. Plate B was cold rolled 36% from a second one inch thick plate which was beta heat treated and quenched before cold rolling. Following cold rolling, both plates were given a 3 hr heat treatment in Ar gas at 620° C. Plate A had a uniform fine recrystallized grain structure. Plate B had a coarse grained lath alpha-zirconium microstructure in part of the plate thickness and a recrystallized grain structure in the remainder. Zircaloy-2 has a low volume fraction of second phase particles that contribute to the plastic deformation behaviour and corrosion resistance of the alloy. The mean second phase particle diameter of Plate A was 0.20 μm. The mean second phase particle diameter of Plate B was 0.075 μm.

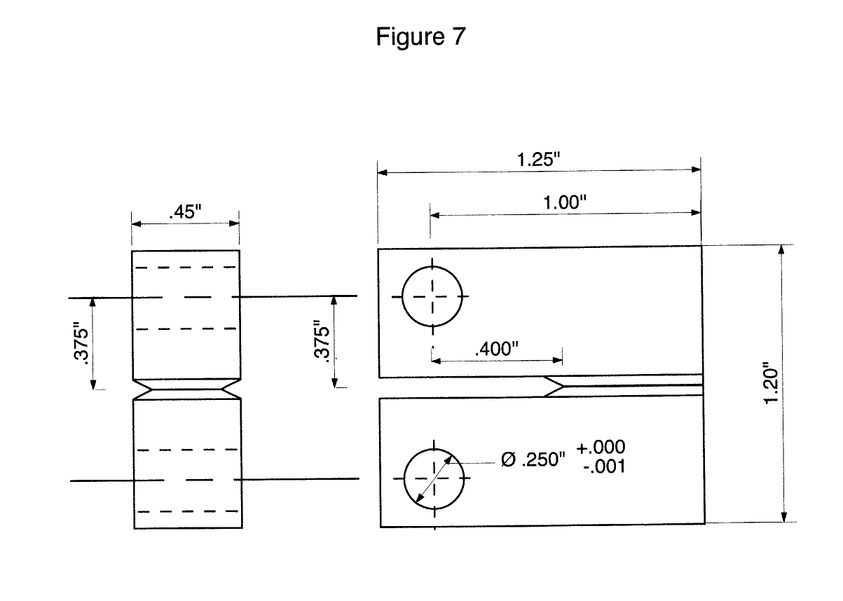

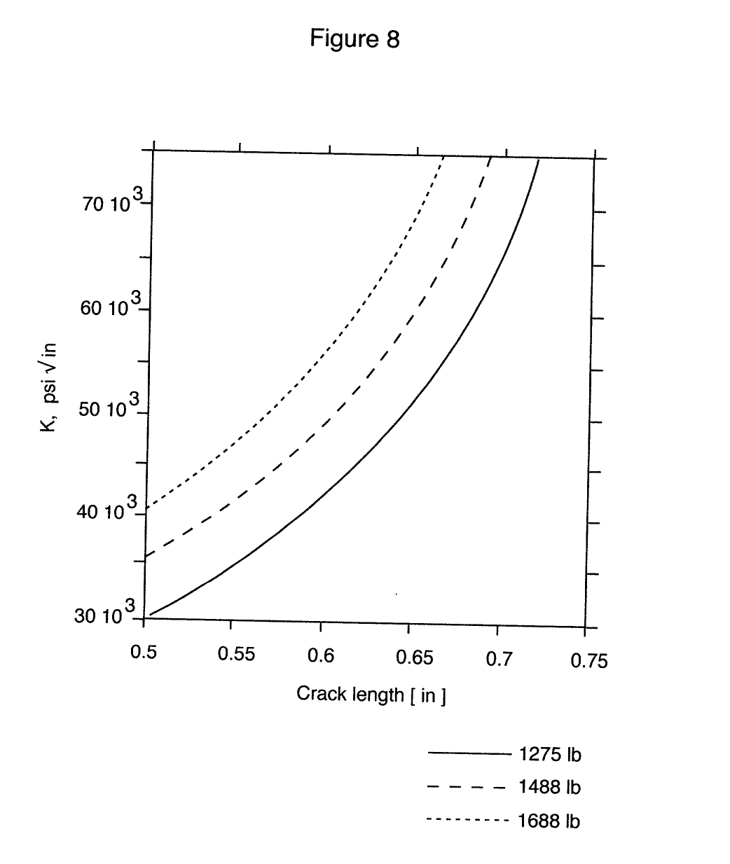

Fatigue precracked side grooved compact tension (CT) fracture specimens 0.45 inches thick were machined from Plates A and B with a TL fracture orientation. The specimens were fatigue precracked to an initial crack length of 0.5 inches. The dimensions of the side grooved CT specimens and the variation of stress intensity of the specimen for three different applied loads are shown in FIGS. 7 and 8. The crack length of the specimens was monitored during the tests using the reversing DC potential drop technique, as disclosed by W. R. Catlin, D. C. Lord, T. A. Prater and L. E. Coffin in Automated Test Methods for Fracture and Fatigue Crack Growth, ASTM STP 877, ASTM, Philadelphia, Pa., 1985, pp 67-85.

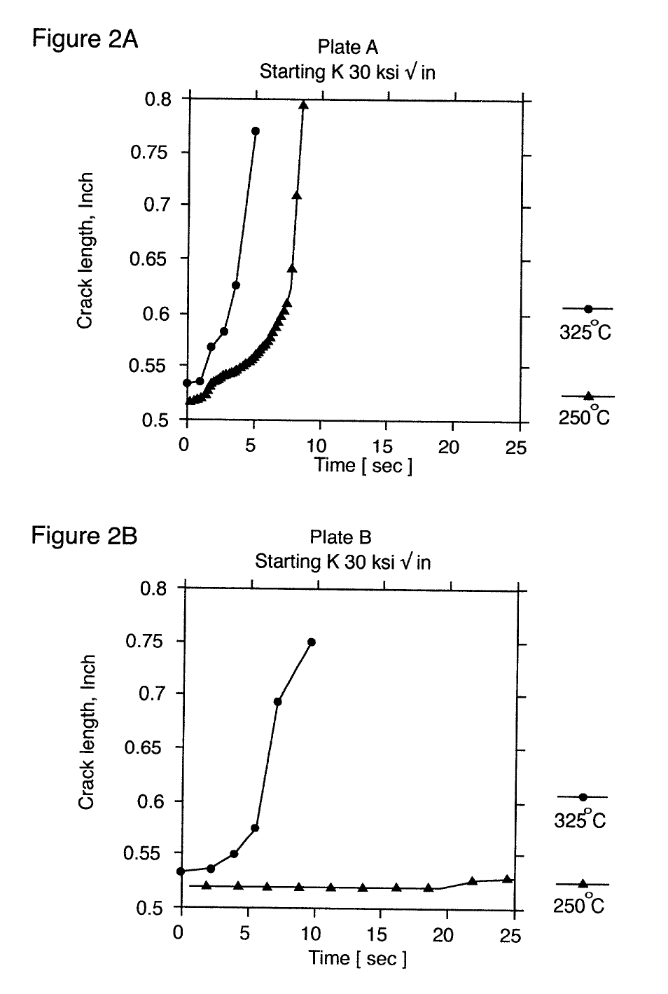

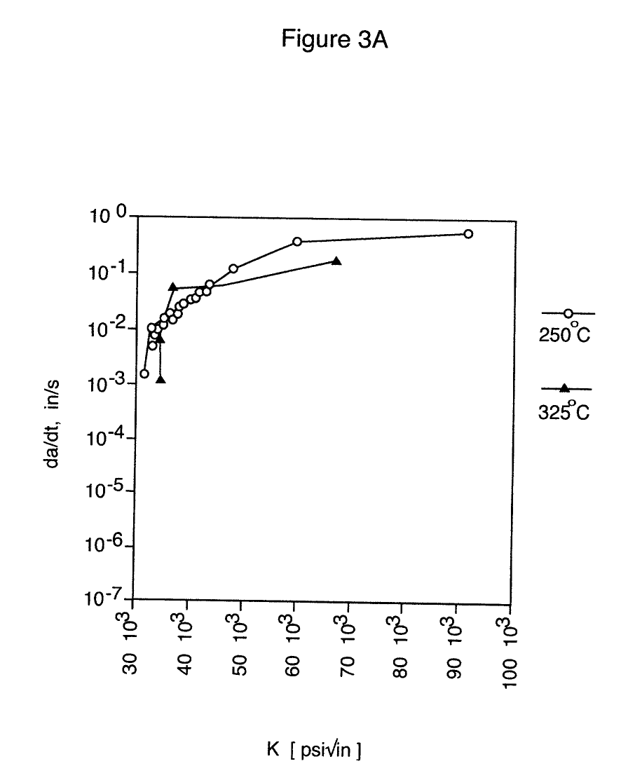

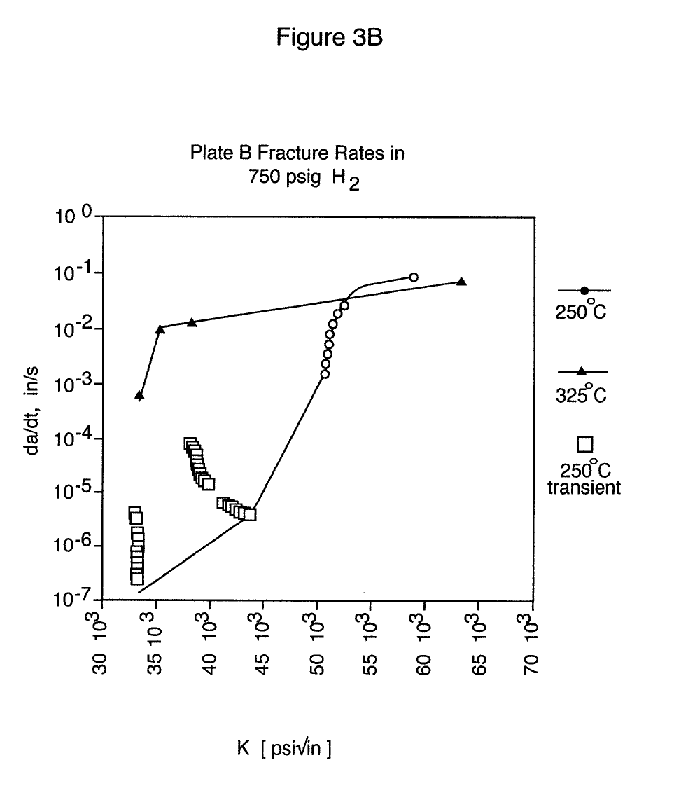

Specimens of Plates A and B were tested in hydrogen gas at 325° C. at a gas pressure of 750 psig and at an initial stress intensity of approximately 32 ksi√in. The tests were performed in an austenitic stainless steel pressure vessel. FIGS. 2A and 2B compare crack length vs time for Plates A and B. FIGS. 3A and 3B show the rate of crack propagation vs nominal stress intensity for Plates A and B, respectively.

Both Plates A and B exhibited an initial rapid acceleration of crack propagation rate followed by deceleration to a maximum crack propagation rate of approximately 0.05 to 0.1 in/s. This maximum rate of crack propagation may be limited by the rate of absorption of hydrogen into plastically deformed Zircaloy-2 at the crack tip.

The effect of temperature on the rate of hydrogen gas cracking was also determined at an initial stress intensity of 32 ksi√in. Hydrogen cracking in plate A was rapid at both 250° C. and 325° C., FIGS. 2A and 3A. Tests on Plate A that were conducted at 250° C. exhibited low cracking rates at the initial stress intensity of 32 ksi√in., but the rate of crack propagation at the highest stress intensifies was very similar for both temperatures.

There was a very large difference between the crack propagation rates of Plates A and B at 250° C. The 250° C. sample of Plate B exhibited transient cracking at a rate of 3×10⁻⁶ in/s which dropped to a steady state rate of 10⁻⁷ in/s, FIGS. 2B and 3B. At this rate, there was essentially no cracking in Plate B relative to the rate of cracking of Plate A.

The stress intensity of the 250° C. Plate B sample was increased from 34 ksi√in to 39 ksi√in which led to another transient increase in the crack propagation rate to 1×10⁻⁴ in/s followed by a drop to a steady state rate of 5×10⁻⁶ in/s. It is believed that the behaviour of Plate B at 34 and 39 ksi√in was consistent with transient growth of the crack tip plastic zone size under primary creep conditions. Once an equilibrium plastic zone size was achieved, steady state creep rates controlled the rate of crack advance. For this reason, FIG. 3B shows the locus of steady state cracking rates in addition to the transient cracking behaviour.

The stress intensity of the 250° C. hydrogen gas test of Plate B was increased to 51 ksi√in which led to crack propagation which rapidly accelerated to a rate of nearly 0.1 in/s. Failure of the specimen then occurred. This suggests that there is both a minimum crack tip strain rate and a minimum stress intensity required for rapid hydrogen gas cracking. The significance of the results are that Plate B did not crack rapidly under conditions which caused failure of Plate A in hydrogen gas at 250° C. The stress intensity that was required to fracture Plate B in hydrogen at 250° C. was 60% higher than the initial stress intensity that led to fracture of Plate A.

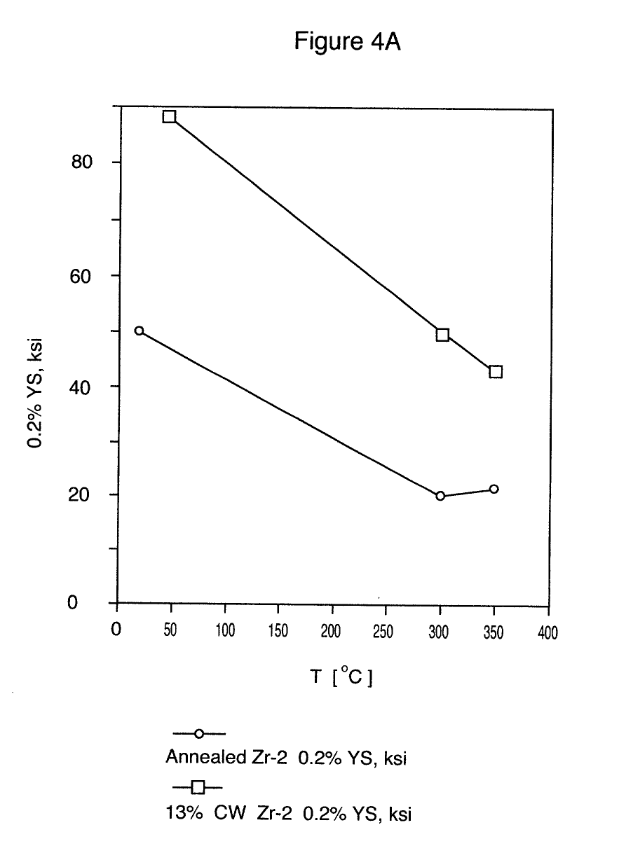

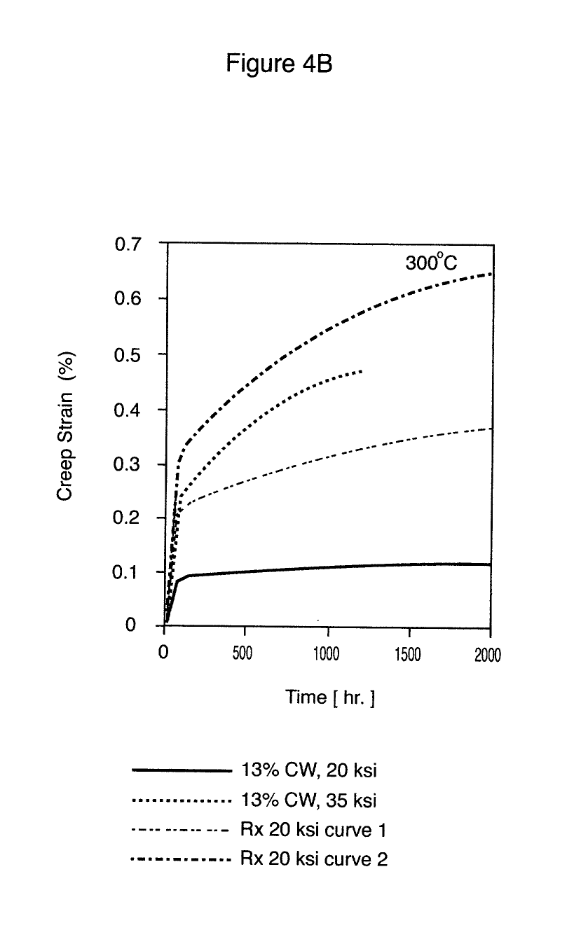

The yield strength of cold-worked Zircaloy-2 is more than double that of recrystallized Zircaloy-2 at 325° C. FIG. 4A shows the tensile yield strengths of 13% cold-worked and recrystallized Zircaloy-2 from room temperature to 350° C. The yield strength of the 36% cold worked Plate B sample that was tested is expected to be comparable.

The relative creep stresses of cold-worked and recrystallized Zircaloy-2 are approximately proportional to their relative yield strengths. The 300° C. creep curves for 13% cold worked and recrystallized Zircaloy-2 are shown in FIG. 4B both for comparable applied stresses and for comparable creep strains. Two creep curves are shown for the recrystallized plate because of sample-to-sample variation. It is evident that the creep behaviour of the stronger cold worked material at 35 ksi is nearly equivalent to the behaviour of recrystallized Zircaloy-2 at 20 ksi.

A fatigue precracked 35% cold-worked CT fracture specimen was tested in 750 psig hydrogen at 325° C. at a stress intensity of 25 ksi√in. In contrast to the behaviour of the recrystallized plate at 30 ksi√in, the 35% cold-worked CT fracture specimen did not exhibit hydrogen gas cracking. The sample was held for 10 h with no cracking. Rather than crack, the specimen experienced significant exfoliation due to surface hydriding.

The difference in behaviour between cold-worked and partially recrystallized Plate B may be due to either their difference in creep strength or the lower applied stress intensity of the cold-worked sample. It is believed that both were factors. This result is significant because it indicated that no hydrogen gas fracture occurred at low stress intensifies relative to the creep cracking threshold of the material.

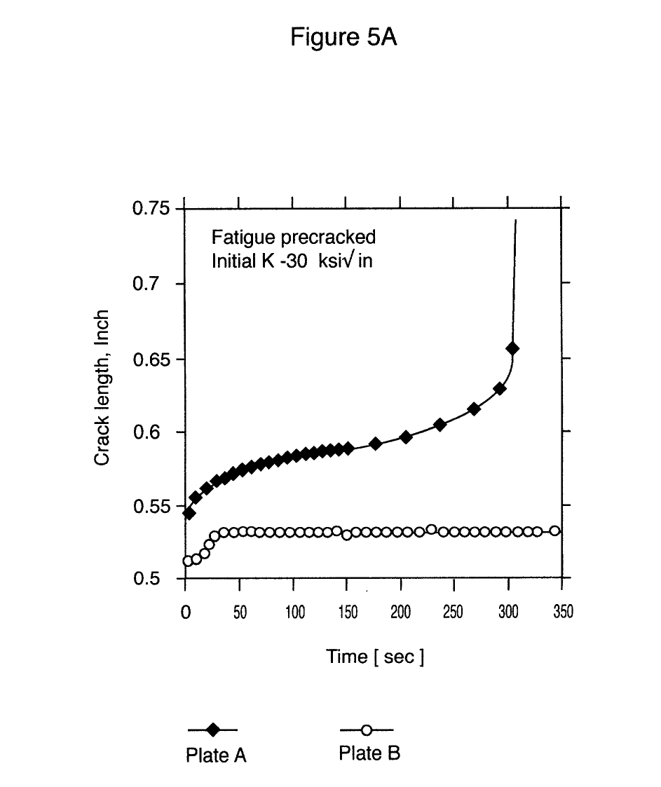

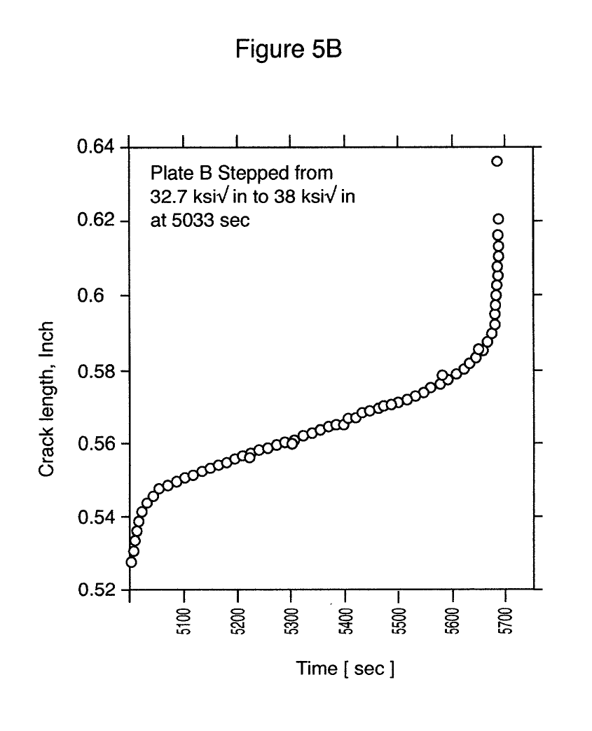

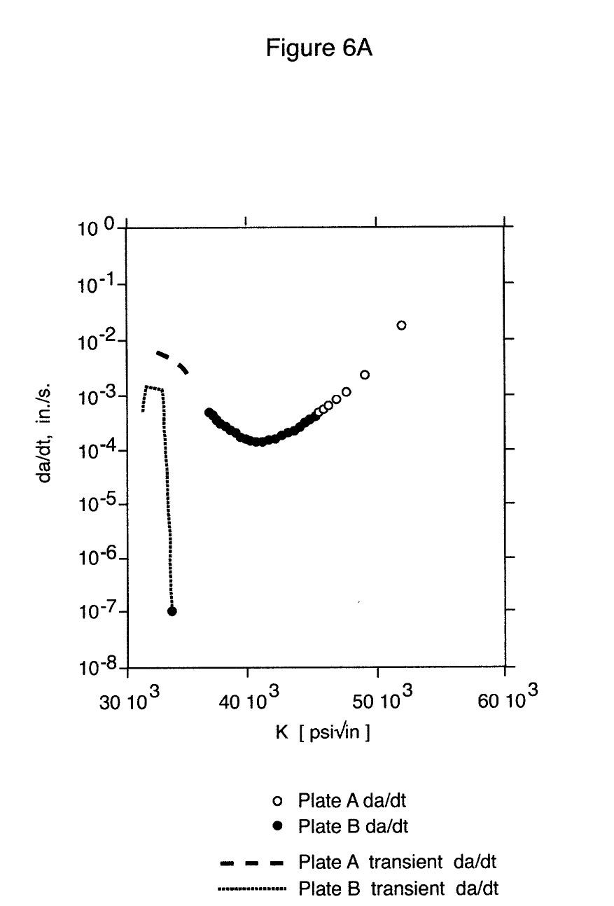

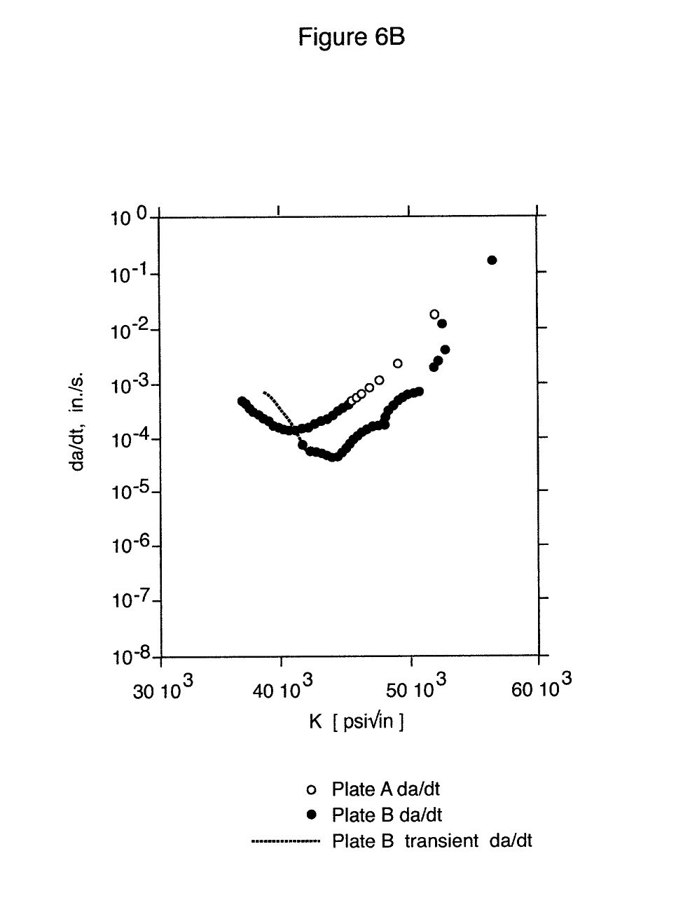

Fatigue precracked CT fracture specimens of Plates A and B were also tested in air. The crack lengths of Plates A and B in air at 325° C. are plotted vs time in FIG. 5A for an initial stress intensity of 32 ksi√in. FIG. 5B shows the crack propagation rate of Plate B after incrementally increasing the stress intensity to 38 ksi√in. The rate of crack propagation for each test is plotted vs nominal stress intensity in FIGS. 6A and 6B.

Plate A exhibited steady crack growth in air at 325° C. at an initial rapid rate which dropped to a slower steady state rate of 1.5×10⁻⁴ in/s approximately 175 s. after load application. The crack propagation rate then accelerated to a rate of 10⁻² in/s as the stress intensity increased because of crack extension. Specimen failure occurred. SEM fractography showed that fracture was by ductile microvoid nucleation and growth. Similar transient high rate cracking, slower steady state cracking and tertiary cracking behaviour has been observed in creep cracking of rotor steels. The failure of Plate A in air at 325° C. is thus best described as creep cracking.

Plate B exhibited an initial crack growth rate of 10⁻³ in/s in air at 325° C. at the same 32 ksi√in stress intensity, FIGS. 5A and 6B. The crack propagation rate of Plate B dropped rapidly to 10⁻⁷ in/s immediately after loading, however. Further crack advance was minimal. After 5000 s, the stress intensity of Plate B was increased to 38 ksi√in and the resulting crack advance is shown in FIG. 5B. After loading to 38 ksi√in, the sample exhibited a transient high propagation rate followed by a slower steady state rate and then acceleration to failure at higher stress intensifies. The minimum crack propagation rate of Plate B was 5×10⁻⁵ in/s. which occurred at a stress intensity of 45 ksi√in. SEM fractography showed that failure was also by ductile microvoid nucleation and growth.

The sequence of crack propagation rate for Plate B above 38 ksi√in was similar to that of Plate A except that comparable rates of cracking occurred at higher stress intensities. Since the rate of crack propagation in creep cracking are controlled by crack tip creep rates, the difference in crack propagation rate for Plates A and B suggests that Plate B had greater creep resistance than Plate A.

A comparison of 325° C. air and hydrogen cracking of Plate A in FIGS. 2A and 2B and 5A and 5B showed that the rate of cracking of Plate A in hydrogen gas at 750 psig was much faster than the rate of creep cracking in air at the stress intensity. The initial rate of cracking in both air and hydrogen were similar, but while air cracking followed a curve of decreasing crack rate, hydrogen cracking accelerated rapidly to a maximum value of 0.05 to 0.15 in/s. SEM fractography showed that the sample that was tested in air had a locally ductile micro dimpled fracture surface while the sample of Plate A that was tested in hydrogen had a perfectly brittle fracture surface.

Accelerated cracking of Plate B samples occurred in hydrogen gas at 325° C. and at a stress intensity of 32 ksi√in. Cracking of Plate B under similar conditions in air resulted in virtually no crack propagation. The initial rate of crack propagation for air and hydrogen gas samples was comparable, but cracking accelerated to a maximum value quickly in the hydrogen gas environment. Like Plate A, the Plate B sample that was tested in hydrogen had a perfectly brittle fracture surface while the air tested fracture surface had the appearance of microvoid coalescence.

The fracture behavior of Plates A and B in air at 325° C. were qualitatively similar except for the difference in the rate of cracking. Both failed in air by a microvoid coalescence separation mode. Creep cracking is supported by studies of creep cracking in rotor steels as the mechanism of failure for the air tests.

It is believed that hydrogen gas absorption in the crack tip region modifies the plastic zone so that it can fracture after less plastic strain than is required for the microvoid coalescence failure mode that occurs in air. The results also suggest that plastic deformation at the crack tip accelerates hydrogen absorption into the crack tip region. The reason for this is that hydriding must occur at a rate that is much faster than the rate of static surface hydriding to produce the crack growth rates that we have observed. Rapid absorption of hydrogen at the crack tip is also supported by observation of a 10-15 μm thick hydride layer at the fracture surface of the hydrogen gas fractures specimens only in the regions where the plastic zone formed during cracking.

During the hydriding and fracture process, it is believed that cracking of the hydrided plastic zone advances the crack tip into new undeformed material which would itself then experience high rate primary or transient creep. This cycle then rebuilds the hydrogen rich zone and causes additional fracture and crack advance.

The rate of hydrogen gas fracture is hence controlled by the rate of creep at the crack tip. Without a stress intensity that is high enough to sustain plasticity at the crack tip, we do not expect rapid hydrogen gas fracture. This belief is supported by the slow cracking of Plate B at 250° C. and stress intensities of 39 ksi√in and below and by the lack of cracking of cold-worked Zircaloy-2 at 325° C. at a stress intensity of 25 ksi√in.

It will be understood, of course, that modifications can be made in the embodiments of the invention described herein without departing from the scope and purview of the invention as defined by the appended claims.

What is claimed:

1. A creep resistant zirconium alloy comprising a coarse grained lath alpha microstructure.

2. The zirconium alloy as claimed in claim 1 wherein the microstructure includes small second phase precipitates.

3. The zirconium alloy as claimed in claim 1 wherein the small second phase precipitates have a diameter less than 0.15 μm.

4. The zirconium alloy as claimed in claim 3 wherein the microstructure is partially recrystallized.

5. The zirconium alloy as claimed in claim 4 wherein the microstructure is less than 50% recrystallized.

6. The zirconium alloy as claimed in claim 1 wherein the microstructure has an acicular structure which includes a lath spacing within the range from about 0.5 to about 3.0 μm.

7. The zirconium alloy as claimed in claim 5 wherein the microstructure is an acicular structure and includes a lath spacing within the range from about 0.5 to about 3.0 μm.

8. A nuclear fuel cladding comprising an annular layer of the creep resistant zirconium alloy as claimed in claim 1.

9. A nuclear fuel cladding comprising an annular layer of the creep resistant zirconium alloy as claimed in claim 7.

10. A method of manufacturing a creep resistant zirconium alloy comprising the steps of:
beta heat treating a zirconium alloy to form a first intermediate;
fast quenching the first intermediate to form a second intermediate;
cold working the second intermediate within the range from about 30% to about 40% to form a third intermediate; and
annealing the third intermediate to effect partial recrystallization.

11. The method as claimed in claim 10 wherein the beta heat treating step has a duration within the range from about 1 to about 10 seconds.

12. The method as claimed in claim 11 wherein the fast quenching step is conducted at a cooling rate within the range from about 20 to about 200° C./second.

13. The method as claimed in claim 12 wherein the annealing step is conducted within the temperature range from about 570° C. to about 640° C.

14. A fuel cladding for use in a nuclear reactor for cladding nuclear fuel, comprising:
a tube member; and
said tube member comprised of a zirconium alloy, said alloy having a coarse grained lath alpha microstructure.

15. The nuclear fuel cladding as claimed in claim 14, wherein said microstructure includes a lath spacing within the range from about 0.5 to 3.0 μm.

16. A fuel cladding for use in a nuclear reactor for cladding nuclear fuel, comprising:
a tube member; and
said tubular member having an inner annular layer, which forms an inner diameter of said tubular member,
said annular layer comprised of a zirconium alloy, having a course grained lath alpha microstructure.

17. A fuel cladding as claimed in claim 16, wherein said microstructure includes a lath spacing in the range of 0.5 to 3.0 μm.
